(19) United States
(12) Patent Application Publication
(10) Pub. No.: US 2018/0336662 A1
(43) Pub. Date: Nov. 22, 2018

(54) IMAGE PROCESSING APPARATUS, IMAGE PROCESSING METHOD, IMAGE CAPTURING APPARATUS, AND STORAGE MEDIUM

(71) Applicant: CANON KABUSHIKI KAISHA, Tokyo (JP)

(72) Inventor: Yoshinori Kimura, Utsunomiya-shi (JP)

(21) Appl. No.: 15/978,555

(22) Filed: May 14, 2018

(30) Foreign Application Priority Data
May 17, 2017 (JP) 2017-098231

(51) Int. Cl. G06T 3/40; G06T 5/00

(52) U.S. Cl. CPC G06T 3/4076; G06T 3/4046; G06T 2207/20052; G06T 3/4084; G06T 2207/20081; G06T 5/003

(57) ABSTRACT

An image processing apparatus includes a weighting unit configured to calculate an error between an estimated image obtained by providing an input image to a convolution neural network and a ground truth image corresponding to the input image and to weight a frequency component of the error, and a parameter setter configured to calculate a gradient based on the weighted error, and to set a network parameter for the convolution neural network.

### BACKGROUND OF THE INVENTION

### Field of the Invention

The present invention relates to an image processing technology that accurately restores a high-frequency component in SRCNN as a super-resolution (“SR”) method using a convolution neural network (“CNN”).

### Description of the Related Art

The SRCNN is a method that generates a high-resolution image from a low-resolution image through the CNN as disclosed in Chao Dong, Chen Change Loy, Kaiming He, Xiaoou Tang, “Image super-resolution using deep convolutional networks,” IEEE Transactions on Pattern Analysis and Machine Intelligence, USA 2015, pp. 295-307. The CNN is an image processing method that repeats a nonlinear process after a filter convolution for an input image, and generates a target output image.

The filter is generated by learning the following training image, and there are generally a plurality of filters. A plurality of images obtained by the nonlinear process after the filter convolution for the input image will be referred to as a feature map. Moreover, a series of processes containing the nonlinear process after the filter convolution for the input image are expressed with a unit referred to as a layer, such as a first layer and a second feature map. For example, the CNN that repeats the filter convolution and the nonlinear process three times will be referred to as a three-layer network.

The CNN can be formulated as follows:

$${X}_{n}^{( l )} = f ( {\sum }_{k = 1}^{K} {W}_{n}^{( l )} * {X}_{n - 1}^{( k )} + {b}_{n}^{( l )} ) \qquad ( 1 )$$

In the expression (1), Wₙ is a filter for an n-th layer, bₙ is a bias for the n-th layer, f is a nonlinear process operator, Xₙ is a feature map for the n-th layer, and * is a convolution operator. (1) on the right side is a first filter or feature map. The nonlinear process can utilize a conventional sigmoid function or a rectified linear unit (ReLU) having a superior convergence. ReLU is given as follows:

f_{ReLU}(Z)=max(0,Z) (2)

In other words, it is the nonlinear process that outputs 0 for negative components in an input vector Z and Z as it is for positive components.

The super-resolution is image processing that generates (or estimates) an original high-resolution image from a low-resolution image obtained by an image sensor with rough pixel resolution (or large pixel sizes). The super-resolution requires a high-frequency component of a high-resolution image to be accurately restored (or to be sharpened so as to remove blurs), which is lost by an aperture of a pixel in an optical system that forms an optical image and an image sensor that photoelectrically converts the optical image.

A pair of training images that include a low-resolution training image and a corresponding high-resolution training image (ground truth image) are initially prepared for the SRCNN. Next, CNN network parameters, such as the above filter and bias, are set through learning so as to accurately convert a low-resolution input image into a high-resolution converted image. Learning the CNN network parameters can be formulated as follows:

$$W = W + η \frac{\partial L}{\partial W} \qquad ( 3 )$$

In the expression (3), W is a filter, L is a loss function, and η is a learning rate. The loss function is used to evaluate an error between an obtained high-resolution estimated image and a ground truth image in inputting the low-resolution training image into the CNN. The learning rate η serves as the step size in the gradient descent method. A gradient in the loss function relating to each filter can be calculated from a differential chain rate. The expression (3) represents learning the filter, but this is similarly applied to the bias.

The expression (3) represents a learning method that updates the network parameter so as to reduce the error between the estimated image and the ground truth image. This learning method is referred to as a back propagation method. The loss function will be described in detail in the following embodiments according to the present invention.

Next, the SRCNN uses the learning generated CNN network parameters for the super-resolution process that generates a high-resolution image based on an arbitrary low-resolution image in accordance with the expression (1).

The learning in the SRCNN requires repetitive calculations and generally needs a long time. However, once the network parameters are learned, the super-resolution process can be performed at a high speed. In addition, the SRCNN has a high generalization ability or can provide a good super-resolution even to the unlearned image. Thereby, the SRCNN can provide a faster and more accurate super-resolution process than another technology.

The SRCNN cannot accurately restore a high-frequency component in the high-resolution image. This is evident from the loss function that uses the SRCNN. The loss function using the SRCNN is given as follows:

L(X,Y)=∥X−Y∥₂² (4)

In the expression (4), X is a high-resolution estimated image having a high resolution obtained in inputting the low-resolution training image into the CNN, and Y is a high-resolution training image (ground truth image) corresponding to the low-resolution input training image. ∥Z∥₂ is a L2 norm and briefly a square-root of sum of squares of components in the vector Z. The expression (4) uses a sum of squares of the difference between both images as an error between the high-resolution estimated image and the ground truth image.

The expression (4) applies an equal weight to frequencies from a low-frequency component to a high-frequency component and calculates a difference between the high-resolution estimated image and the ground truth image. However, in general, a natural image contains mainly a low-frequency component and a smaller amount of a high-frequency component and thus this error evaluation cannot evaluate the restoration of the high-frequency component in the high-resolution estimated image. In other words, the loss function is a function that cannot restore the high-frequency component since the error is small as long as the low-frequency component is restored in estimating the high-resolution image.

For the above reasons, the high-resolution component in the high-resolution image cannot be accurately restored in the CNN network parameters learned from the loss function in the SRCNN.

### SUMMARY OF THE INVENTION

The present invention provides an image processing apparatus and an image processing method etc. which can set a CNN network parameter that can accurately restore a high-frequency component in a high-resolution image.

An image processing apparatus according to one aspect of the present invention includes a weighting unit configured to calculate an error between an estimated image obtained by providing an input image to a convolution neural network and a ground truth image corresponding to the input image and to weight a frequency component of the error, and a parameter setter configured to calculate a gradient based on the weighted error, and to set a network parameter for the convolution neural network.

Further features of the present invention will become apparent from the following description of exemplary embodiments with reference to the attached drawings.

### BRIEF DESCRIPTION OF THE DRAWINGS

FIG. 1 is a block diagram of a structure of an image capturing apparatus having an image processing apparatus according to embodiments of the present invention.

FIG. 2 is a flowchart representing an image processing method executed by the image processing apparatus.

FIG. 3 explains a weight coefficient of a step function shape used for a first embodiment of the present invention.

FIGS. 4A to 4C illustrate a numeric calculation result that explains the effects of the first embodiment.

FIG. 5 illustrates a numeric calculation result according to the prior art.

FIG. 6 compares the first embodiment with the prior art frequency region.

FIG. 7 explains a weight coefficient of a linear function shape used for a second embodiment of the present invention.

FIG. 8 illustrates a numeric calculation result according to the second embodiment.

### DESCRIPTION OF THE EMBODIMENTS

Referring now to the accompanying drawings, a description will be given of embodiments of the present invention.

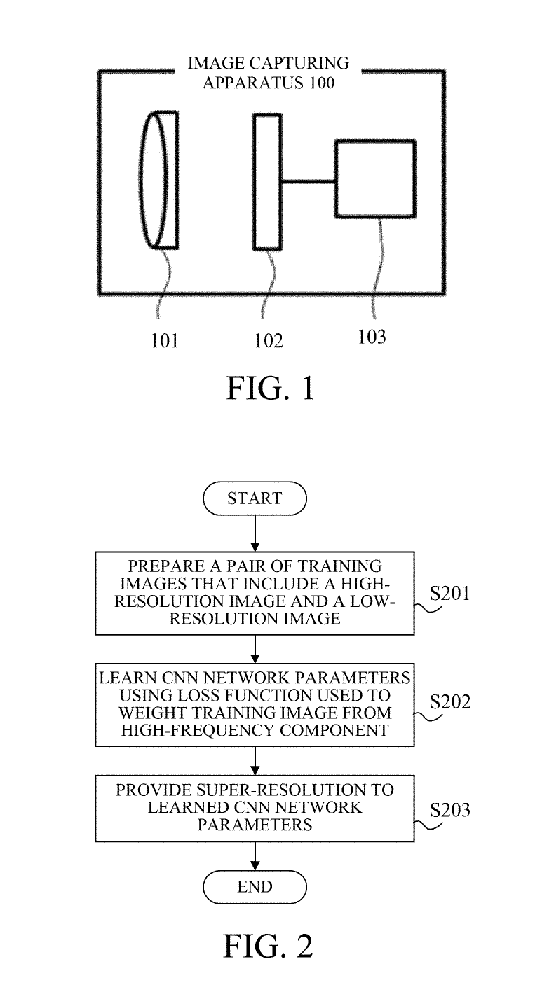

Before specific embodiments (numerical examples) according to the present invention are explained, a representative embodiment according to the present invention will be described. FIG. 1 illustrates a structure of an image capturing apparatus 100 that includes an image processing apparatus 103 according to the embodiment of the present invention.

The image capturing apparatus 100 includes an imaging optical system 101, an image sensor 102, and the image processing apparatus 103. The imaging optical system 101 forms an optical image (object image) on an image capturing plane of the image sensor 102. The imaging optical system 101 includes one or more lenses, and may include a mirror, a refractive index distribution element, or a DMD (digital mirror device). The imaging characteristic of the imaging optical system 101 may be unknown or known. The imaging characteristic is a point spread function (“PSF”) representing a blur of the optical image for a condition, such as an angle of view, an object distance, a wavelength, and a luminance. The imaging optical system 101 is given by the convolution integral of the PSF in the image processing.

The image sensor 102 includes a CMOS (complementary metal oxide semiconductor) image sensor, photoelectrically converts the object image formed on the image capturing plane, and outputs an electric signal according to a light intensity of the object image. The image sensor 102 is not limited to the CMOS image sensor and may use another unit as long as it can output an electric signal corresponding to a light intensity, such as a CCD (charge coupled device) image sensor. An action of the image sensor 102 is given by down sampling that averages, through a spread (aperture effect) in one pixel, a plurality of pixels obtained by photoelectrically converting a high-resolution optical image so as to provide one pixel in a low-resolution image.

The image processing apparatus 103 includes a calculation unit, such as a personal computer (PC) and a workstation, and provides the following image processing to a captured image generated as an input image with an electric signal output from the image sensor 102. The image processing apparatus 103 may execute an image processing program (application) as a computer program stored in an unillustrated internal memory, or include a circuit board mounted as the program. The image processing program stored in an external storage medium, such as a semiconductor memory and an optical disc, may be read and executed for image processing.

The image capturing apparatus 100 may be an optical-system integrated type in which the imaging optical system 101 is integrated with the image sensor 102, or an optical-system interchangeable type in which the imaging optical system 101 is interchangeable. For the optical-system interchangeable type, a suitable parameter for the imaging optical system 101 to be used may be used as a parameter (CNN network parameter) for the following image processing. This is because it is necessary to set the parameter according to the imaging characteristic of the imaging optical system 101.

Referring to a flowchart illustrated in FIG. 2, a description will be given of an image processing (method) executed by the image processing apparatus 103. “S” stands for a step or process. The image processing apparatus 103 serves as a weighting unit or a parameter setter.

In the step S201, the image processing apparatus 103 prepares a pair of training images that include a low-resolution training image as an input image and a high-resolution training image (ground truth image) corresponding to the low-resolution training image. When the imaging optical system 101 has a known imaging characteristic, a low-resolution training image may be generated from a high-resolution training image through a simulation using a computer. In other words, the low-resolution training image may be generated by convoluting the PSF as the imaging characteristic of the imaging optical system 101 with the high-resolution training image, and by adding influence of the image sensor 102 to the obtained optical image (down sampling).

When the imaging optical system 101 has an unknown imaging characteristic, a low-resolution training image may be generated by capturing a known high-resolution pattern (such as a bar chart) using the image capturing apparatus 100.

Each training image may be a color or monochromatic image, but this embodiment assumes that each training image is the monochromatic image in the following description. When the training image is the color image, the following image processing may be applied for each color channel or only to a luminance component in the color image.

This embodiment bicubic-interpolates a low-resolution training image and makes its size equal to that for the high-resolution training image in accordance with Chao Dong, Chen Change Loy, Kaiming He, Xiaoou Tang, “Image super-resolution using deep convolutional networks,” IEEE Transactions on Pattern Analysis and Machine Intelligence, USA 2015, pp. 295-307. For example, in the super-resolution magnification factor 2, the low-resolution image has half a size as that of the high-resolution image but the interpolation process enlarges to upscale the size of the low-resolution image with upscaling magnification factor 2 so as to equalize sizes of both training images.

In the step S202, the image processing apparatus 103 learns the convolution neural network (CNN) network parameter from the training image. In this case, a function given as follows is used for the loss function.

L(X,Y)=∥Ψ(X−Y)∥₂² (5)

In the expression (5), X is a high-resolution estimated image obtained by inputting a low-resolution training image into the CNN, and Y is a high-resolution training image (ground truth image) corresponding to the input low-resolution training image. Ψ is a (high-frequency weighting) matrix weighting the high-frequency component, and given as follows:

Ψ=Φ⁻¹ΓΦ (6)

In the expression (6), b is a discrete cosine transform (“DCT”) matrix used for the DCT for the frequency decomposition, and Γ is a weighting coefficient matrix. The weighting coefficient matrix Γ is a diagonal matrix having a diagonal component with a weighting coefficient that weights the CDT coefficient (discrete cosine transform coefficient) obtained by the DCT matrix. This weighting coefficient determining method will be described in detail in the following embodiment.

The expression (6) applies a weighting coefficient matrix to a high-frequency coefficient (high-frequency DCT coefficient) corresponding to a predetermined high-frequency component among the DCT coefficients (frequency coefficients) for each frequency component obtained by DCT-converting a difference image representing a difference (error) between the high-resolution estimated image and the ground truth image. This configuration weights the high-frequency DCT coefficient. Moreover, the expression (6) means the DCT inverse conversion of the weighted high-frequency DCT coefficient (weighted high-frequency coefficient). In other words, the expression (6) weights the high-frequency component that is less contained in the natural image and applies a heavy penalty unless the high-frequency component is well restored in the high-resolution estimated image. The high-frequency component can be accurately restored by using the CNN network parameter learned with the loss function. In addition, the learning uses an error back propagation method described in the expression (3). The gradient in the loss function used in the error back propagation method is given as follows.

$$\frac{\partial L}{\partial X} = 2 {Ψ}^{T} ( Ψ X - {Y}^{′} ) \qquad ( 7 )$$

In the expression (7), Y′ is a high-resolution ground truth image Y weighted by the high-frequency weighting matrix Ψ.

Thus, this embodiment learns the network by weighting the high-frequency component in the estimated error.

The conventional super-resolution weights the high-frequency component in the image but no prior art propose a post-weighting learning method (expression (7)) or the loss function in the expressions (5) and (6) or a learning method using this loss function.

Japanese Patent Laid-Open No. 2014-195333 discloses a method for evaluating a quantized error of a forecast error signal in a video signal using a measurement weighted in a frequency region or a real space and for selecting one of the frequency region and the real space for use with the quantization. The forecast error signal forecasts a difference from the front frame. However, the weight disclosed in the above reference is used for an object opposite to this embodiment because the above reference allows an error at an edge, and does not allow an error at the flat part. In addition, this reference does not disclose learning the network using the measurement weighted in the frequency region.

An illustrated memory or storage may store the previously learned CNN network parameter. A storage medium, such as a semiconductor memory and an optical disc, may store a network parameter, and the stored network parameter may be read out of the storage medium before the following process.

In the step S203, the image processing apparatus 103 generates (estimates) a high-resolution image by using the learned CNN network parameters for an arbitrary low-resolution image (input image) obtained by the image capturing apparatus 100 (image sensor 102). This embodiment uses the super-resolution method expressed by the expression (1).

When the obtained low-resolution image is a color image, the high-resolution image may be generated from the low-resolution image for each color channel by using the CNN network parameter learned for each color channel, and the high-resolution images of the respective color channels may be combined. Alternatively, a high-resolution luminance image may be generated from a low-resolution luminance image by using the CNN network parameter learned from the luminance component in the color image, and the high-resolution luminance image may be combined with an interpolated color difference image.

Moreover, the image processed result may be stored in the unilluminated memory and displayed on the unillustrated display unit.

The above process may generate the high-resolution image from the arbitrary low-resolution image obtained from the image capturing apparatus 100.

Next, specific embodiments will be described.

### First Embodiment

A first embodiment illustrates a numeric calculation result of a super-resolution image (high-resolution image) generated by the above image processing.

The CNN has a three-layer network structure as disclosed in Chao Dong, Chen Change Loy, Kaiming He, Xiaoou Tang, “Image super-resolution using deep convolutional networks,” IEEE Transactions on Pattern Analysis and Machine Intelligence, USA 2015, pp. 295-307. The first layer has a filter size of 9×9×64 (pieces), the second layer has a filter size of 64×1×1×32, and the third layer has a filter size of 5×5×32. Where the input image has a size of Ny×Nx, the second layer converts an Nx×Ny×64-dimensional matrix output from the first layer into an Nx×Ny×32-dimensional matrix.

The first to third filters have learning rates of 10⁻⁴, 10⁻⁷, and 10⁻⁹, respectively. The first to third filters have bias learning rates of 10⁻⁵, 10⁻⁷, and 10⁻⁹, respectively. The filter in each layer has an initial value given by a regular distribution random number, and the bias in each layer has an initial value of 0. The activation functions at the first and second layers use the above ReLU. The number of error back propagations is 3×10⁵.

Assume that the optical system has an equal-magnification ideal lens that has no aberration, an F-number of 2.8, and a wavelength of 0.55 μm. The optical system may have any structures as long as it has a known imaging characteristic. This embodiment does not consider the aberration for simplicity purposes. The image sensor has one pixel size of 1.5 μm, and an aperture ratio of 100%. For simplicity purposes, the image sensor noise is not considered.

The super-resolution magnification factor is 2 (2×). Since the optical system has an equal magnification and the one pixel size in the image sensor is 1.5 μm, the high-resolution image has one pixel size of 0.75 μm.

The training image includes totally 15,000 pairs of monochromatic high-resolution and low-resolution training images with 32×32 pixels. The low-resolution training image is generated through a numeric calculation from a plurality of high-resolution training images when the optical condition, such as the above F-number of 2.8, the wavelength of 0.55 μm, and the equal magnification, and the image sensor with one pixel size of 1.5 μm and the aperture ratio of 100%. In other words, the high-resolution training image with one pixel size of 0.75 μm is blurred under the optical condition, and then the low-resolution training image with one pixel size of 1.5 μm through the above image sensor. As described above, the bicubic interpolation process is performed so that the high-resolution training image and the low-resolution training image have the same size. The low-resolution image obtained by the image capturing apparatus 100 is also bicubic-interpolated and then the super-resolution process is performed for the interpolated image. The high-resolution training image is normalized so that the pixel value has a maximum value of 1.

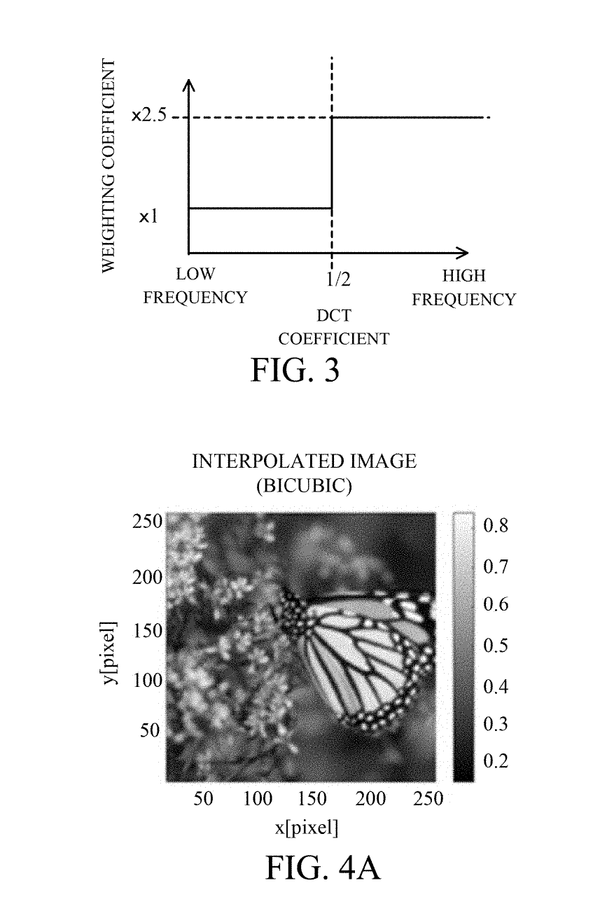

The weighting coefficient in the loss function has a step function shape illustrated in FIG. 3. More specifically, the high-frequency DCT coefficient as the high-frequency component equal to or higher than ½ on the high-frequency side is multiplied by 2.5 among the DCT coefficients calculated from a difference image between the high-resolution estimated image and the ground truth image.

The weighting coefficient is not limited as long as it can apply a uniform weight to the high-frequency DCT coefficient. For example, the weighting coefficient may use a step function as in this embodiment, or a sigmoid function shape in which the step function is made dull. In addition, the high-frequency DCT coefficient that applies a uniform weight is not limited to one strictly corresponding to the high-frequency component equal to or higher than ½ on the high-frequency side as long as it falls within a range equal to or higher than ½ or higher and equal to or lower than ⅔. The uniform weight applied to the high-frequency DCT coefficient is not limited to strictly 2.5 times as long as it falls within a range from 1.5 times or higher to 2.5 times or lower. In other words, the weighting coefficient may be 1.5 or higher and 2.5 or lower.

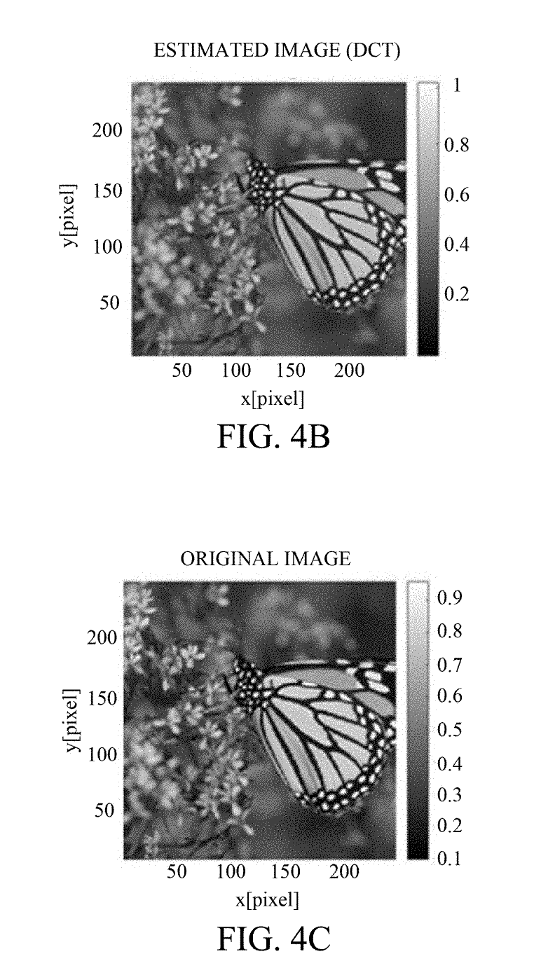

FIGS. 4A to 4C illustrate image processed results. FIG. 4A illustrates a bicubic-interpolated image of the low-resolution image. FIG. 4B illustrates the high-resolution estimated image according to this embodiment. FIG. 4C illustrates a ground truth image. Each image is a monochromatic image having Nx=Ny=256 pixels. It is understood from these figures that this embodiment obtains a sharp (less degraded) estimated image closer to the ground truth image than the bicubic-polarized image.

The effect of this embodiment is quantitatively evaluated by a root mean square error (“RMSE”). The RMSE is given as follows.

$$RMSE ( P , Q ) = \sqrt{\frac{{\sum }_{i = 1}^{M} {( {p}_{i} - {q}_{i} )}^{2}}{M}} \qquad ( 8 )$$

In the expression (8), P and Q are arbitrary M×1-dimensional vectors, and pᵢ and qᵢ are i-th elements in P and Q. As the RMSE is closer to zero, P and Q are more similar to each other. In other words, as the RMSE between the high-resolution estimated image and the ground truth image is closer to zero, the estimated image can be accurately super-resolved.

Table 1 summarizes the RMSE of the ground truth image and the bicubic-interpolated image as the high-resolution image and the RMSE between the ground truth image and the high-resolution estimated image according to this embodiment. Since the latter RMSE is closer to zero than the former RMSE, this embodiment can provide a more accurate super-resolution.

TABLE 1

| | RMSE BETWEEN GROUD |
|---|---|
| RMSE BETWEEN GROUND | TRUTH IMAGE AND |
| TRUTH IMAGE AND | HIGH-RESOLUTION |
| INTERPOLATED IMAGE OF | ESTIMATED IMAGE ACCORDING |
| LOW-RESOLUTION IMAGE | TO THIS EMBODIMENT |
| 0.0630 | 0.0307 |

Next, this embodiment is compared with prior art. The prior art uses SRCNN disclosed in Chao Dong, Chen Change Loy, Kaiming He, Xiaoou Tang, “Image super-resolution using deep convolutional networks,” IEEE Transactions on Pattern Analysis and Machine Intelligence, USA 2015, pp. 295-307. Except for weighting in the loss function, the prior art is similar to this embodiment and a description thereof will be omitted.

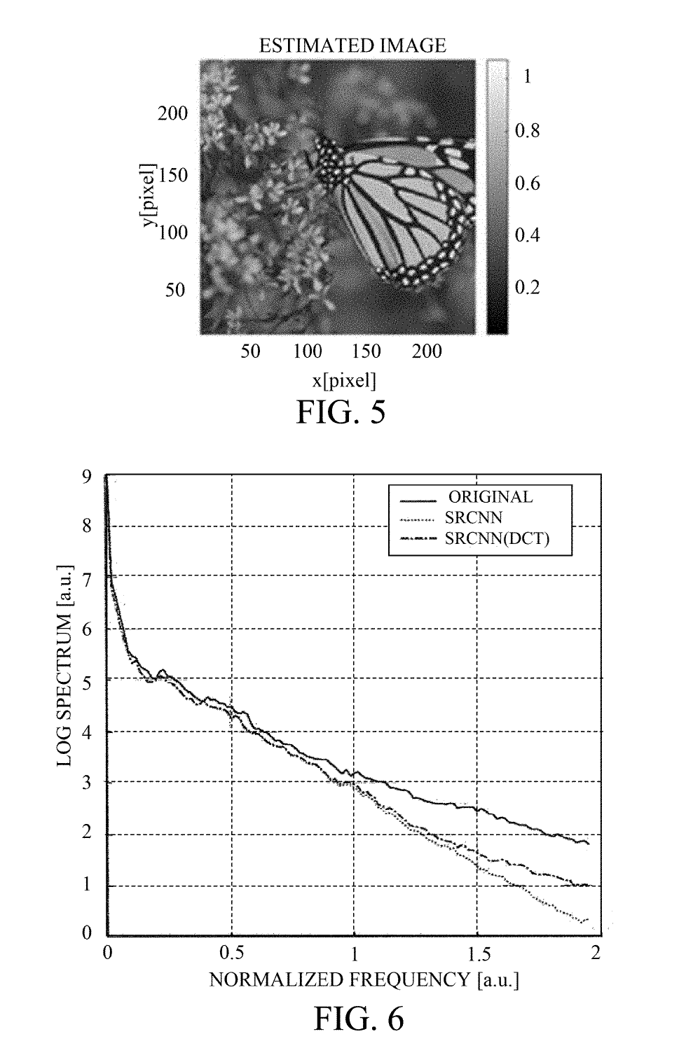

FIG. 5 illustrates a high-resolution estimated image obtained by the prior art. Table 2 illustrates the RMSE between the ground truth image and the high-resolution estimated image obtained by the prior art. Since the RMSE between the ground truth image and the high-resolution estimated image according to this embodiment is closer to zero than the RMSE according to the prior art, this embodiment can provide a more accurate super-resolution.

TABLE 2
RMSE BETWEEN GROUND TRUTH IMAGE
AND HIGH-RESOLUTION IMAGE ACCORDING
TO THE PRIOR ART
0.0319

FIG. 6 illustrates a one-dimensional spectrum comparison result between this embodiment and the prior art. The one-dimensional spectrum is expressed as a one-dimensional vector made by calculating an absolute value of the two-dimensional spectrum obtained through a two-dimensional Fourier transform of the image and by integrating the absolute values in a radial vector direction. In FIG. 6, the abscissa axis denotes a normalized space frequency, which is higher on the right side. The ordinate axis denotes a logarithm value of the one-dimensional vector. The solid line represents the one-dimensional spectrum of the ground truth image, and a dotted line represents the one-dimensional spectrum of the high-resolution estimated image according to the prior art. An alternate long and short dash line represents the one-dimensional spectrum of the high-resolution estimated image according to this embodiment.

In this figure, since the alternate long and short dash line is closer to the solid line than the dotted line in the high-frequency region, it is understood that this embodiment can restore a more high-frequency component than the prior art. The high-frequency component can be increased by applying the noise high-frequency component to the image. However, that case degrades the quality of the image with the increased high-frequency component, and the RMSE between that image and the ground truth image is separated from zero. On the other hand, since the RMSE between the ground truth image and the high-resolution estimated image according to this embodiment is closer to zero than the prior art, the high-frequency component can be more accurately restored.

Thus, this embodiment can more accurately restore the high-frequency component than the prior art.

### Second Embodiment

A second embodiment illustrates a numeric calculation result using a linear function shape (a piecewise linear function correctly speaking) as the weighting coefficient of the loss function. Since this embodiment is different from the first embodiment in weighting coefficient of the loss function, a description of other portions will be omitted.

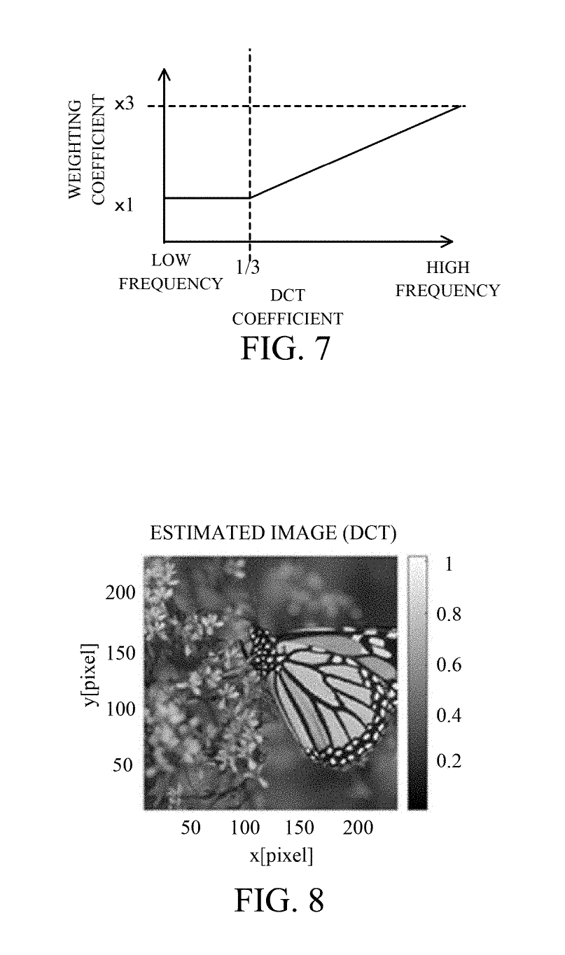

FIG. 7 illustrates a weighting coefficient having a linear function shape according to this embodiment. This weighting coefficient is used to linearly weight the high-frequency DCT coefficient as the high-frequency component equal to or higher than ⅔ on the high-frequency side among the DCT coefficients calculated based on the difference image between the high-resolution estimated image and the ground truth image so as to treble a maximum value of the high-frequency DCT coefficient.

The weighting coefficient is not limited as long as it can apply a monotonously increasing weight to the high-frequency DCT coefficient. For example, the weighting coefficient may have a linear function shape or a curve shape, such as a power function and an exponential function. In addition, the high-frequency DCT coefficient that applies the monotonously increasing weight is not limited to one strictly corresponding to the high-frequency component equal to or higher than ⅔ on the high-frequency side as long as it falls within a range equal to or higher than ⅔ and equal to or lower than ⅘. The maximum value of the monotonously increasing weight applied to the high-frequency DCT coefficient is not limited to strictly 3 times as long as it falls within a range of 3 times or higher and 6 times or lower. In other words, the maximum value of the weighting coefficient may be 3 or higher and 6 or lower.

FIG. 8 illustrates a high-resolution estimated image according to this embodiment. The (bicubic-interpolated image of the) low-resolution image and the ground truth image area are the same as those in the first embodiment. Table 3 illustrates the RMSE between the ground truth image and the high-resolution estimated image according to this embodiment. This RMSE is closer to zero than that between the ground truth image and high-resolution estimated image according to the prior art. In addition, the one-dimensional spectrum evaluation in the frequency space is similar to that in the first embodiment although not specifically illustrated. Thus, this embodiment can obtain a sharp (less degraded) high-resolution estimated image closer to the ground truth image than the prior art.

TABLE 3
RMSE BETWEEN GROUND TRUTH IMAGE
AND HIGH-RESOLUTION ESTIMATED IMAGE
ACCORDING TO THIS EMBODIMENT
0.0305

### Third Embodiment

A third embodiment describes a noise reduction rather than the super-resolution. Even in the noise reduction, the accurate restoration of the high-frequency component is important. This is because it is difficult to distinguish the original high-frequency component in the image and the high-frequency noises from each other in the noise degraded image and it is difficult to well reduce the high-frequency noises from the noise degraded image.

For example, the image processing field removes a spike noise from the noise degraded image by using a median filter. The median filter replaces the pixel value in the target pixel in the noise degraded image with a median in a pixel in the adjacent area of the target pixel. This median filter can remove as the noise the pixel value that is remarkably larger or smaller than the surrounding pixel. However, the high-frequency components in the image, such as an edge, are simultaneously averaged and made dull. It is thus necessary to accurately restore the high-frequency component in the image.

The training image used for learning may be changed in order to apply the image processing described in the first and second embodiments to the noise reduction. More specifically, instead of the low-resolution training image (input image) and the high-resolution training image, the CNN network parameter may be learned by using the (training) noise degraded image and the (training) sharp image that is less degraded by noises. Other portions are similar to those in the first and second embodiments, and a description thereof will be omitted.

### Fourth Embodiment

A fourth embodiment describes a blur removal rather than the super-resolution. Even in the blur removal, the accurate restoration of the high-frequency component is important. This is because the purpose of the blur removal is to restore the high-frequency component in the image that has lost by the aperture of the image sensor and the optical system.

The training image used for learning may be changed in order to apply the image processing described in the first and second embodiments to the blur removal. More specifically, instead of the low-resolution training image (input image) and the high-resolution training image, the CNN network parameter may be learned by using the (training) blurred image and the (training) sharp image that is less degraded by blurs. Other portions are similar to those in the first and second embodiments, and a description thereof will be omitted.

Each of the above embodiments can accurately restore the high-frequency component in the SRCNN as the super-resolution method using the CNN.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-098231, filed on May 17, 2017, which is hereby incorporated by reference herein in its entirety.

What is claimed is:

1. An image processing apparatus comprising:
a weighting unit configured to calculate an error between an estimated image obtained by providing an input image to a convolution neural network and a ground truth image corresponding to the input image and to weight a frequency component of the error; and
a parameter setter configured to calculate a gradient based on the weighted error, and to set a network parameter for the convolution neural network.

2. The image processing apparatus according to claim 1, wherein the error is an image representing a difference between the estimated image and the ground truth image.

3. The image processing apparatus according to claim 1, wherein the weighting unit performs a frequency decomposition of the error and calculates a frequency coefficient for each frequency component, calculates a weighted high-frequency coefficient by applying a weighting coefficient to a high-frequency coefficient corresponding to a predetermined high-frequency component in the frequency coefficient; and performs an inverse frequency decomposition for the weighted high-frequency coefficient.

4. The image processing apparatus according to claim 3, wherein the frequency decomposition is a discrete cosine transform and the frequency coefficient is a discrete cosine transform coefficient.

5. The image processing apparatus according to claim 3, wherein the weighting coefficient is set so as to uniformly weight the high-frequency coefficient.

6. The image processing apparatus according to claim 5, wherein the weighting coefficient falls in a range equal to or higher than 1.5 and equal to or lower than 2.5.

7. The image processing apparatus according to claim 5, wherein the predetermined high-frequency component is equal to or higher than ½ and equal to or lower than ⅔.

8. The image processing apparatus according to claim 3, wherein the weighting coefficient is set so as to apply a monotonously increasing weight to the high-frequency coefficient.

9. The image processing apparatus according to claim 8, wherein the weighting coefficient has a maximum value from 3 to 6 inclusive.

10. The image processing apparatus according to claim 8, wherein the predetermined high-frequency component is equal to or higher than ⅔ and equal to or lower than ⅘.

11. The image processing apparatus according to claim 1, wherein the input image is a degraded image for the ground truth image.

12. The image processing apparatus according to claim 1, wherein the input image is a low-resolution image, the estimated image has a resolution higher than that of the low-resolution image, and the ground truth image has a resolution higher than that of the low-resolution image.

13. The image processing apparatus according to claim 1, wherein the input image is a noise degraded image degraded by noises, the estimated image is less degraded by the noises than the noise degraded image, and the ground truth image is less degraded by the noises than the noise degraded image.

14. The image processing apparatus according to claim 1, wherein the input image is a blurred image, the estimated image is less blurred than the blurred image, and the ground truth image is less blurred than the blurred image.

15. An image capturing apparatus comprising:
an image sensor;
an image processing apparatus that receives as an input image an image obtained through the image sensor,
wherein an image processing apparatus includes:
a weighting unit configured to calculate an error between an estimated image obtained by providing an input image to a convolution neural network and a ground truth image corresponding to the input image and to weight a frequency component of the error; and
a parameter setter configured to calculate a gradient based on the weighted error, and to set a network parameter for the convolution neural network.

16. An image processing method comprising the steps of:
calculating an error between an estimated image obtained by providing an input image to a convolution neural network and a ground truth image corresponding to the input image, and weighting a frequency component of the error; and
calculating a gradient based on the weighted error, and setting a network parameter for the convolution neural network.

17. A non-transitory computer-readable storage medium storing an image processing program that enables a computer to execute an image processing method according to claim 16.
